(19) United States
(12) Patent Application Publication
(10) Pub. No.: US 2011/0123711 A1
(43) Pub. Date: May 26, 2011

(54) METHODS FOR FORMING METAL-POLYMER HYBRID TOOLING FOR FORMING PARTS HAVING MICRO FEATURES

(75) Inventors: Sung-Hwan YOON, Dracut, MA (US); Carol M.F. Barry, Tyngsborough, MA (US); Joey L. Mead, Carlisle, MA (US); Nam-Goo Cha, Boston, MA (US); Ahmed A. Busnaina, Needham, MA (US)

(73) Assignees: UNIVERSITY OF MASSACHUSETTS LOWEL, Lowel, MA (US); NORTHEASTERN UNIVERSITY, Boston, MA (US)

(21) Appl. No.: 12/906,574

(22) Filed: Oct. 18, 2010

Related U.S. Application Data
(63) Continuation-in-part of application No. PCT/US2009/040890, filed on Apr. 17, 2009.
(60) Provisional application No. 61/046,014, filed on Apr. 18, 2008.

(51) Int. Cl. B28B 21/50; B29C 45/00

(52) U.S. Cl. 427/135; 264/328.1; 264/293

(57) ABSTRACT

A method for forming metal-polymer hybrid tooling includes patterning a surface of a member such as a silicon wafer, stainless steel, nickel or nickel alloy, engaging a polymer layer with the patterned features of the surface of the silicon wafer to form the polymer layer having a reverse of the patterned surface the silicon wafer, removing the patterned polymer layer to expose a patterned polymer layer surface, depositing a metallic layer on the patterned polymer layer surface, and wherein the deposited metallic layer on the patterned polymer layer is operable to form parts with features having a width dimension between about 0.01 microns and about 100 microns and a height dimension of between about 0.01 micron and about 800 microns (e.g., up to aspect ratio of 8).

### CLAIM TO PRIORITY

This application is a continuation-in-part of PCT International Application No. PCT/US2009/040890 filed on Apr. 17, 2009, and published in English on Oct. 22, 2009, as WO 2009/129430, which claims the benefit of U.S. Provisional Patent Application No. 61/046,014, filed Apr. 18, 2008, entitled “Methods For Forming Metal-Polymer Hybrid Tooling For Forming Parts Having Micro Features,” the entire subject matter these applications being hereby incorporated herein by reference.

### GOVERNMENT RIGHTS

The U.S. government may have certain rights in this application pursuant to National Science Foundation grant #NSF-0425826.

### FIELD OF THE INVENTION

This invention relates generally to tooling and more specifically, to methods for forming tooling for forming parts having micro features.

### BACKGROUND OF THE INVENTION

Although a number of micro-molding techniques, including nanoimprint and hot embossing, have been proposed for the production of nanoscale features, injection molding technology offers the most competitive potential to produce components with nanoscale features in economically viable manner due to its far higher molding speed than the other techniques.

Steel, aluminum, and beryllium-copper alloys, have been used as conventional mold tooling materials. Conventional machining technologies such as CNC machining with limited resolution of 100 μm are not suitable for producing nanoscale features.

To attain the feature sizes needed for micromolds, toolmakers have turned to high precision electro discharge machining (i.e., WEDM), lithographic and etching techniques traditionally used in semiconductor fabrication, LIGA, and laser ablation. Micro-wire EDM uses a 20 μm diameter wire to cut through conductive workpiece, but it is not sufficiently reliable with suitable resolution. Laser ablation provides resolution of 1 μm for metallic micro mold. LIGA is a leading micromachining technology that used high energy x-rays from a synchrotron to create high aspect-ratio micro-devices having accuracy of 0.5 μm. However, it has some disadvantages such as abrasion and wear of nickel, which is most common material for LIGA, slow process of electroplating, and high cost of the light source from synchrotron. There are other options such as UV and electron beam lithography on silicon wafer. The current resolution limit of UV lithography is 157 nm, and sub-10 nm is possible with E-beam lithography. The primary substrate material for these processes is silicon rather than steel.

Becker and Heim utilized silicon wafers for hot embossing, describing the advantages of silicon tooling including hardness, linear thermal expansion coefficient, thermal conductivity, and the flat surface. H. Becker, and U. Heim. In IEEE International Conference on Micro Electro Mechanical Systems; Institute of Electrical and Electronics Engineers: Orlando, 1999; Vol. Technical Digest, pp 228-231. Su et al. introduced wet etched silicon wafers (minimum feature sized of 40 μm) as a direct tooling material for injection molding. Y. C. Su, J. Shah, and L. Lin, Journal of Micromechanics and Microengineering, 14, 415-422 (2004). Electroforming of nickel on top of the silicon was used for hot embossing lithography by Heyderman et al. and the feature size of 50 nm was achieved. L. J. Heyderman, H. Schift, C. David, B. Ketterer, M. A. d. Maur, and J. Gobrecht, Microelectronic Engineering, 57-58, 375-380 (2001). D'Amore et al. used silicon wafer with V-shaped grooves to evaluate moldability and molding quality of injection-compression process. A. D'Amore, M. Gabriel, W. Haese, H. Schift, and W. Kaiser. In Kunststoffe plas europe, 2004; Vol. 2, pp 4-7. However, Liyong Yu et al. used silicon wafers as a sacrificial substrate for making nickel mold insert through UV-lithography and electrodeposition of nickel, since the group believed the brittle nature of silicon wafer was not suitable for bona-fide tooling material for molding. L. Yu, C. G. Koh, K. W. Koelling, L. J. Lee, and M. J. Madou. In Annual Technical Conference—Society of Plastics Engineers, 2001; Vol. 1, pp 785-789.

With regard to semiconductor fabrication, photo lithography is typically used for chip fabrication. It is a pattern (photomask) transferring method to the surface of a chip substrate.

There is a need for further method for forming tooling for forming parts having micro features.

### SUMMARY OF THE INVENTION

In a first aspect, the present invention includes a method for forming a metal-polymer hybrid tooling for molding a plurality of parts having micro features. The method includes patterning a surface of a member having patterned features having width dimension of between about 0.01 microns and about 100 microns, and a height dimension of between about 0.01 microns and about 800 microns, engaging a polymer layer with the patterned features of the surface of the member to form the polymer layer having a reverse of the patterned surface the member, removing the patterned polymer layer to expose a patterned polymer layer surface, and depositing a metallic layer on the patterned polymer layer surface, the metallic layer comprising a thickness of between about 0.5 microns and about 500 microns, and patterned features having width dimension of between about 0.01 microns and about 800 microns. The deposited metallic layer on the patterned polymer layer is operable to form parts having patterned features having a width dimension between about 0.01 microns and about 500 microns and a height dimension of between about 0.01 micron and about 800 microns.

In a second aspect, the present invention includes method for forming a metal-polymer hybrid tooling for molding a plurality of parts having micro features. The method includes engaging a polymer layer with the patterned features of the surface of the member to form the polymer layer having a reverse of the patterned surface the member, the surface of the member having patterned features having width dimension of between about 0.01 microns and about 100 microns, and a height dimension of between about 0.01 microns and about 800 microns, removing the patterned polymer layer to expose a patterned polymer layer surface, depositing a metallic layer on the patterned polymer layer surface, the metallic layer comprising a thickness of between about 0.5 microns and about 500 microns, and patterned features having width dimension of between about 0.01 microns and about 800 microns, and wherein the deposited metallic layer on the patterned polymer layer is operable to form parts having patterned features having a width dimension between about 0.01 microns and about 500 microns and a height dimension of between about 0.01 micron and about 800 microns.

In a third aspect, the present invention includes a method for forming a plurality of parts having micro features. The method includes providing the metal-polymer hybrid tooling such as disclosed above, providing a moldable material, and forming the moldable material using the metal-polymer hybrid tooling to produce the plurality of parts having features having a width dimension between about 0.01 microns and about 500 microns and a height dimension of between about 0.01 micron and about 800 microns.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a diagrammatic illustration of a hybrid tooling preparation process in accordance with the present invention;

FIG. 2 is a is a diagrammatic illustration of a comparison of the pattern shape of photolithography with positive (right) and negative (left) photoresist, which may be employed in the process of FIG. 1;

FIG. 3 is an illustration of lithographic printing method, which may be employed in the process of FIG. 1.

FIG. 4 is a diagrammatic illustration of a hybrid tooling preparation process and forming of a molded product in accordance with the present invention;

FIG. 5 is a table of the comparison of printing and related techniques;

FIG. 6 is a diagrammatic comparison of conventional lithography and nanoimprint lithography;

FIG. 7 is an SEM image of a tooling surface of an FOTS coated silicon tooling;

FIG. 8 is an SEM image of a tooling surface of an aluminum-polymer tooling;

FIG. 9 is an SEM image of a tooling surface of a titanium-polymer tooling;

FIG. 10 is an SEM image of a molded part surface from FOTS coated silicon wafer;

FIG. 11 is an SEM image of a molded part surface from aluminum-polymer tooling in accordance with the present invention;

FIG. 12 is an SEM image of a molded part surface from titanium-polymer tooling in accordance with the present invention;

FIG. 13 is a graph of the comparison of molding result in depth ratio;

FIG. 14 is a graph of the heat transfer analysis results for Si-FOTS tooling;

FIG. 15 is a graph of the heat transfer analysis results for Al-polymer tooling; and

FIG. 16 is a diagrammatic illustration of another embodiment of a hybrid tooling preparation process in accordance with the present invention.

### DETAILED DESCRIPTION OF THE INVENTION

This present invention employs, in one embodiment, a series of techniques such as lithography, nanoimprinting, and metal sputtering to fabricate the novel metal-polymer hybrid tooling. The present invention is also directed to molding of parts having high resolution employing such novel metal hybrid tooling and evaluation of various tooling surfaces such as titanium, and aluminum. Parts were molded using polystyrene and replication quality was determined using optical profiler and scanning electron microscopy. Heat transfer analysis was done to compare the novel tooling with silicon tooling and cooling time optimization. The present invention may be inexpensive and may be mass produced for high resolution micron tooling and may include nano scale resolution.

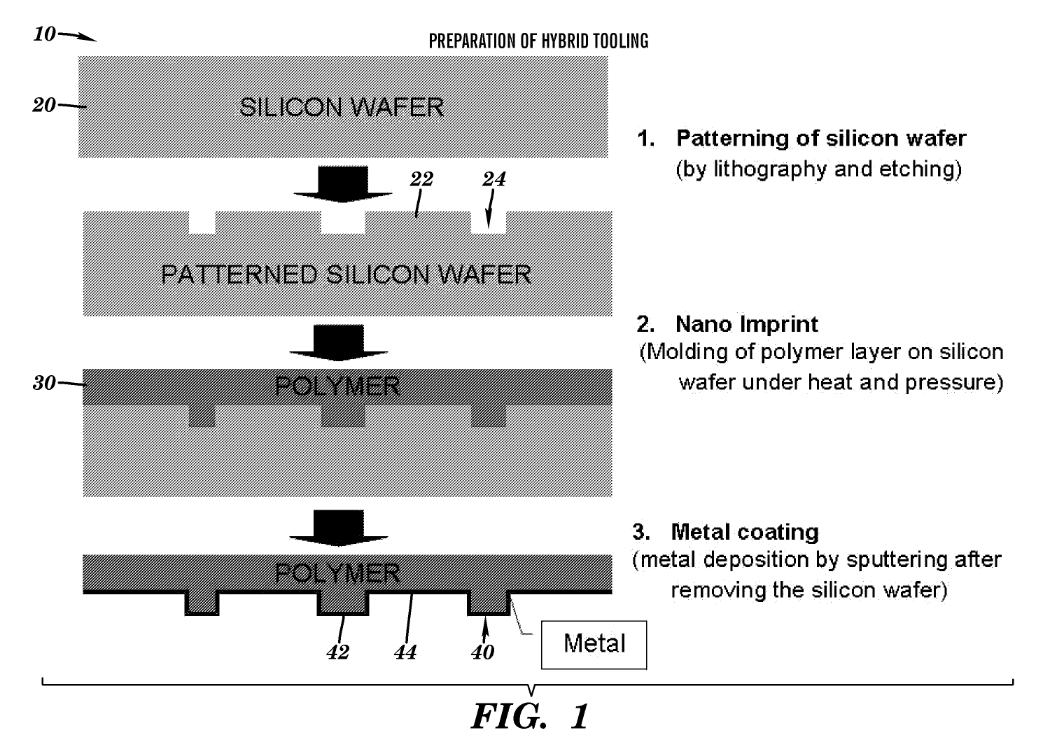

FIG. 1 is a diagrammatic illustration of one such embodiment of a method 10 for forming a novel metal-polymer hybrid tooling in accordance with the present invention. For example, in this illustrative embodiment, the present invention may initially include patterning a surface of a member such as a silicon wafer 20 to a desired resolution using a suitable photolithography process to provide the desired resolution. For example, the patterned surface may have features such as lands 22 and grooves 24. The size of the lands and grooves may be between about 0.01 microns (μm) and about 100 microns wide and a height or depth between about 0.01 microns and about 800 microns. Preferably, the size of the lands and grooves may be between about 0.01 micron and about 100 microns wide and a height or depth between about 0.01 micron and about 800 microns, e.g., with an aspect ratio of up to about 8. The size of the lands and grooves may also include lands and grooves about 10 microns (μm) wide and a height or depth of about 10 microns resulting in an aspect ration of 1. The required cycle time may be several hours depending on the pattern and equipment employed. Additional ranges for the various features of the patterned surface of the silicon wafer may be suitably selected depending on the filed of application such as for forming biosensors, optical devices, and microfluidics.

The next step may employ a nanoimprinting, melting, or depositing of a polymer material onto the patterned silicon wafer. The pattern is then transferred to the polymer layer 30 such as a polymer sheet. The polymer may be any thermoplastic or thermoset polymer. For example, the polymer layer may be polycarbonate, polyimide, polyester, liquid crystal polymer, or other suitable materials. Another process such as nanoimprint lithography may be employed instead which transfer or copies the pattern from the silicon wafer to polymer base sheet by applying compression, heat and pressure. The overall cycle time may be about 15 minutes. While hot press with heat may be employed, dedicated nanoimprint equipment may be preferable and may afford better results.

The next step is applying a metal coating 40 on the nanoimprinted polymer layer. For example, the metallic layer may be deposited using a sputtering process. The nanoimprinted polymer layer may be coated, for example using a sputtering process, employing at least one of aluminum, titanium, nickel, chromium, tungsten, gold, or and alloys containing at least one of aluminum, titanium, nickel, chromium, tungsten, gold, titanium on the patterned polymer layer surface which may form a major component or percentage of the alloy. Depending on the capability of sputtering equipment and the type of metal deposited, the required time may vary significantly, but generally no more than one hour. The typical thickness of the deposited metallic layer is about 0.5 micros to about 500 microns.

The resulting tooling may include a patterned surface having features such as lands 42 and grooves 44. The size of the lands and grooves of the tooling may be between about 0.01 microns (μm) and about 500 microns wide and a height or depth between about 0.01 micron and about 800 microns. Preferably, the size of the lands and grooves of the tooling may be between about 0.01 microns and about 100 microns wide and a height or depth between about 1 micron and about 800 microns, e.g., having an aspect ratio up to 8. The size of the lands and grooves of the tooling may also include lands and grooves about 10 microns wide and a height or depth of about 10 microns resulting in an aspect ratio of 1.

Additional ranges for the various features of the patterned surface of the tooling may be suitably selected depending on the filed of application such as for forming biosensors and microfluidics. For example, the size of the lands and grooves of the tooling may be about 50 microns wide and a height or depth about 50 microns. For optical devices, the size of the lands and grooves of the tooling may be about 100 microns wide and a height or depth about 100 microns.

Using a single cavity injection molding machine, 3-d plastic chips were able to be made in less than one minute. If used in an industrial setting, this process may be scaled up because manufacturers typically use injection molding machines with multiple cavities.

In addition, the present invention reduces the need for special equipment and skill sets as required for photolithography. The required cycle time for tooling preparation is several hours depending on the pattern and choice of equipment. Benefits for the present technology include the following:
1) The replication may be consistently four times better in depth ratio than current micron scale techniques.
2) The tooling preparation may be much faster requiring several hours as compared to a week for conventional preparation, i.e., WEDM and nickel electroplating.
3) A less expensive tooling preparation technique may be required since polymer based material are used which are inexpensive and readily available, and the usage of the metallic material is minimal for sputtering and allows for a generally uniform metallic layer. In comparison, electroplating is a slow process and it is difficult to control the uniformity of the surface.
4) Aspect ratio is not distorted because during injection molding the pattern is sustained in hot temperature, therefore the pattern remains intact.

The present invention for forming the metal-polymer hybrid tooling for microinjection molding may incorporate the following processes as follows.

### Photo Lithography

Photolithography (or optical lithography) is a process used in semiconductor device fabrication to transfer a pattern from a photomask (also called reticle) to the surface of a substrate. It bears a similarity to the conventional lithography used in printing and shares some of the fundamental principles of photographic processes.

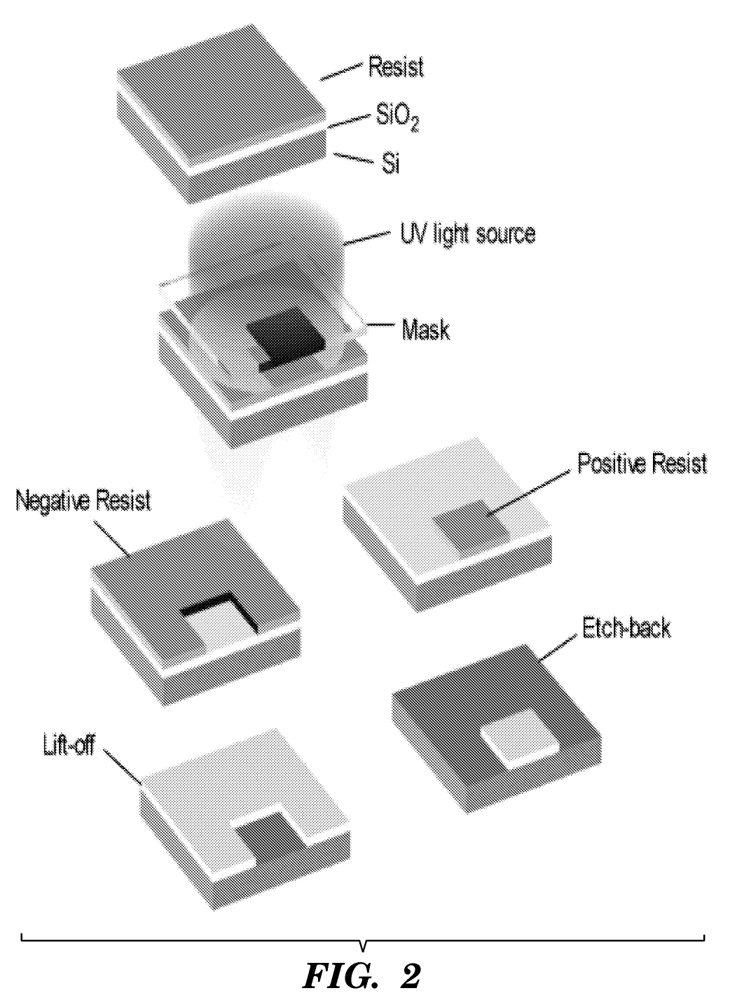

Some photoresist work well under broadband ultraviolet light, whereas others are designed to be sensitive at specific frequencies to ultraviolet light. It is also possible to use other types of resist that are sensitive to X-Rays and others that are sensitive to electron-beam exposure. Photoresists are simply classified into two groups, positive resists and negative resists. A positive resist is a type of photoresist in which the part of the photoresist that is exposed to light becomes soluble to the photoresist developer and the part of the photoresist that is unexposed remains insoluble to the photoresist developer. A negative resist is a type of photoresist in which the part of the photoresist that is exposed to light becomes relatively insoluble to the photoresist developer. The unexposed part of the photoresist is dissolved by the photoresist developer. FIG. 2 illustrates a comparison of the pattern shape of photolithography with positive (right) and negative (left) photoresist.

One exposure system is a contact printer or proximity printer. A contact printer involves putting a photomask in direct contact with the wafer. A proximity printer puts a small gap in between the photomask and wafer. The photomask pattern is directly imaged onto the photoresist on the wafer in both cases. The resolution is roughly given by the square root of the product of the wavelength and the gap distance. Hence, contact printing with zero gap distance ideally offers best resolution. The commonly used approach for photolithography is projection lithography.

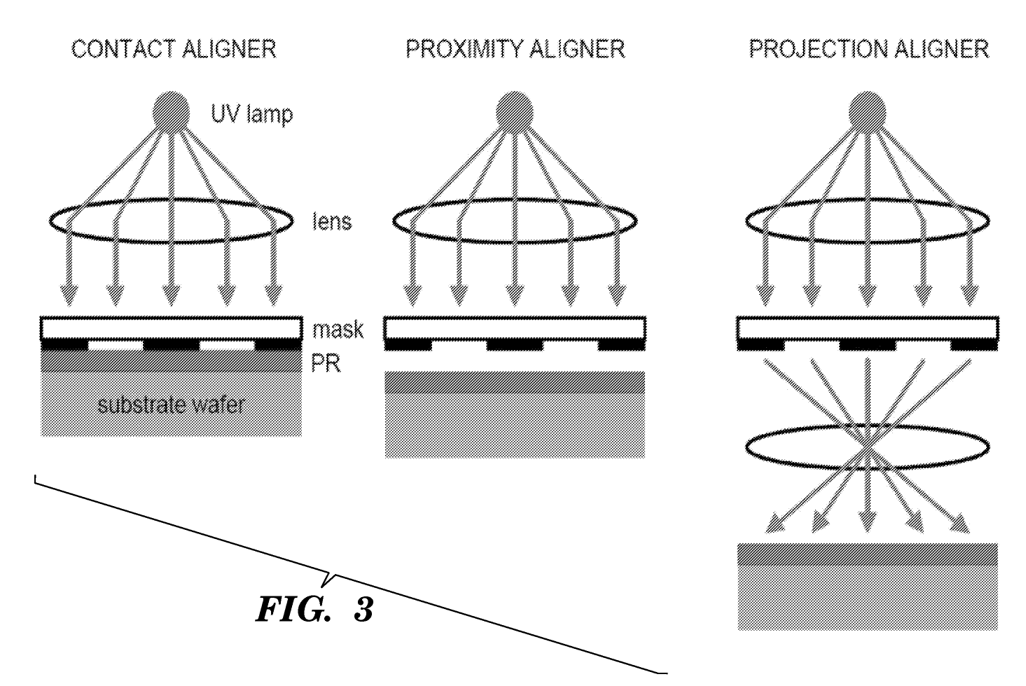

FIG. 3 illustrates a desired pattern projected from the photomask onto the wafer in either a machine called a stepper or scanner. The stepper/scanner functions similarly to a slide projector. Light from a mercury arc lamp or excimer laser is focused through a complex system of lenses onto a mask, containing the desired image. The light passes through the mask and is then focused to produce the desired image on the wafer through a reduction lens system. The reduction of the system can vary depending on design, but is typically on the order of 4×-5× in magnitude. Lithography is desirably used because it affords exact control over the shape and size of the objects it creates, and because it can create patterns over an entire surface simultaneously.

### Fabrication of Patterned Silicon Wafer

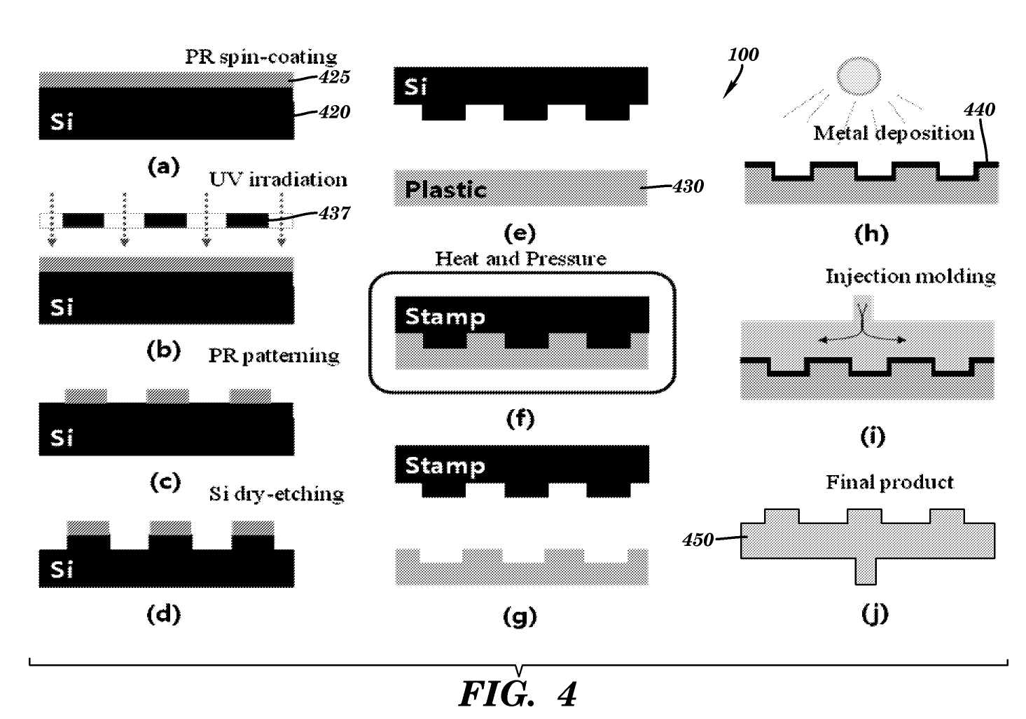

FIG. 4 illustrates another embodiment of a process 100 for forming a novel metal-polymer hybrid tooling in accordance with the present invention. For example, at (a), a four-inch Si(100) wafer 120 having a 150 nm thermal oxide layer, were prepared for the hot embossing mold. A thermal oxide wafer was cleaned in piranha solution (H₂SO₄:H₂O₂=4:1) and D.I.-water rinsed. A layer 425 of positive photoresist (AZ1512, Clariant Corporation, USA) was spin-coated at 3000 rpm for 30 seconds. The coated photoresist had a 1 μm thickness and baked on a hot plate at 100° C. for 1 minute. At (b), the surface was exposed by using a UV Aligner (EVG, EVG620, Austria) through a photomask and the photoresist was developed. The photomask 427 had various pattern widths ranging from 1 μm to 500 μm. The patterned photoresist wafer was dry-etched at (c) by using an oxide etcher (AS1045, A-Tech, Korea) to have 10 μm depths. The antistiction layer was coated on the Si mold by using SAM (self assembly monolayer) method. The mold Si wafer was fabricated after an antistiction coating as shown at (d).

Nanoimprint equipment (NX2000, Nanonex, USA) was used to fabricate the imprinted plastic wafer. Various kinds of plastics (such as PMMA, PC, Teflon, Polyimide etc) were tested for imprinting process. The fabricated Si mold was carefully mounted at (e) into a clamp and sandwiched with a plastic wafer 430. At (f), a hot embossing process was achieved as a function of temperature and pressure. Conventionally, hot embossing process was archived at above glass temperature of plastics. At (g), de-embossing was conducted at room temperature. After the imprinting process, all of the results were observed by optical microscope (L150A, Nikon, Japan).

At (h), metal deposition (such as Ni, Cr, Ta, Au, Al, etc) was done on imprinted the plastic wafer. Each metal deposition 440 depends on machine and plasma conditions (FIG. 4(h)). In case of Al deposition, process was achieved at 12 mTorr of working pressure and 6 A of plasma power for 12 minutes to make 500 nm thicknesses using Perkin-Elmer Plasma System.

Using this metal deposited imprinted plastic mold, named a hybrid mold, injection molding process achieved at optimized conditions, at (i). Molding was performed using a 3 ton micro injection molding machine (Nissei, model: AU3E) with a two-stage injection unit. The nozzle, joint, and plunger temperatures were set at 216° C. which is a lower bound of recommended temperature by manufacturer and the cooling time was set to 12 seconds. Injection pressure was set to 45 MPa and the average cycle time was about 19 seconds, at (i). Final plastic product 450 was received after injection molding process at (j).

### Nanoimprint Lithography (NIL)

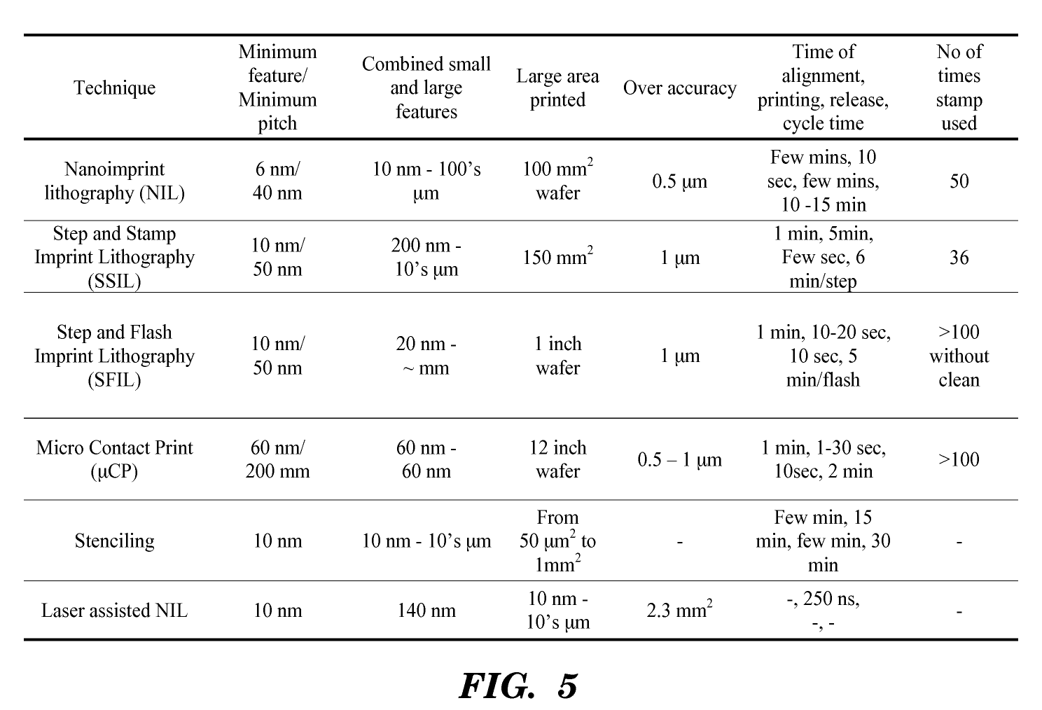

Nanoimprint lithography is a method of fabricating nanometer scale patterns. It is a process with low cost, high throughput and high resolution. It creates patterns by mechanical deformation of imprint resist and subsequent processes. The imprint resist is typically a monomer or polymer formulation that is cured by heat or UV light during the imprinting. Adhesion between the resist and the template is controlled to allow proper release. There are many different types of NIL, but two of them are preferred: Thermoplastic NIL (T-NIL) and Step and Flash Imprint Lithography (S-FIL). FIG. 5 illustrates the comparison of printing and related techniques.

Nanoimprint lithography has been used to fabricate device for electrical, optical, photonic and biological applications. For electronics devices, NIL has been used to fabricate MOSFET, O-TFT, and single electron memory. For optics and photonics, intensive study has been conducted in fabrication of subwavelength resonant grating filter, polarizer, waveplate, anti-reflective structure, integrated photonics circuit, and plasmontic device by NIL. Sub-10 nm nanofluidic channels had been fabricated using NIL and used in DNA stretching experiment. Currently, NIL is used to shrink the size of biomolecular sorting device an order of magnitude smaller and more efficient.

A benefit of nanoimprint lithography is there is no need for complex optics or high-energy radiation sources. There is no need for finely tailored photoresists designed for both resolution and sensitivity at a given wavelength. The simplified requirements of the technology also lead to its low cost, another key benefit. Since large areas can be imprinted in one step, this is also a high-throughput technique.

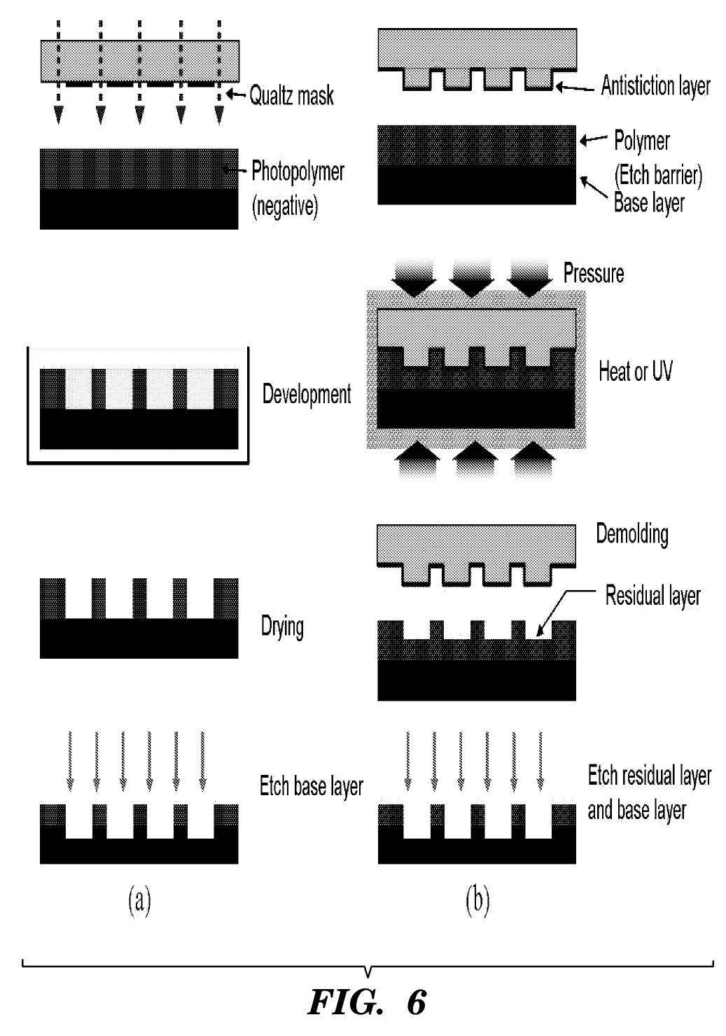

A key concerns for nanoimprint lithography are overlay, defects, and template patterning. Due to the direct contact involved, the potential for error in overlay and potential for defects are magnified compared to cases where the image is projected from a distance. These can be mitigated with the use of effective step-and-imprint and template cleaning strategies, respectively. The current overlay 3 sigma capability is 10 nm. The template patterning can currently be performed by electron beam lithography; however at the smallest resolution, the throughput is very slow. As a result, optical patterning tools will be more helpful if they have sufficient resolution. FIG. 6 shows the comparison of conventional lithography at (a) and nanoimprint lithography at (b).

A key characteristic of nanoimprint lithography is the residual layer following the imprint process. It is preferable to have thick enough residual layers to support alignment and throughput and low defects. However, this renders the nanoimprint lithography step less critical for critical dimension (CD) control than the etch step used to remove the residual layer. Hence, it is important to consider the residual layer removal an integrated part of the overall nanoimprint patterning process. In a sense, the residual layer etch is similar to the develop process in conventional lithography. It has been proposed to combine contact lithography and nanoimprint lithography techniques in one step in order to eliminate the residual layer.

As nanoimprint lithography is a simple pattern transfer process that is neither limited by diffraction nor scattering effects nor secondary electrons, and does not require any sophisticated radiation chemistry, it represents the final, ultimate form of lithography. However, a lingering barrier to nanometer-scale patterning is the current reliance on other lithography techniques to generate the template. It is possible that self-assembled structures will provide the ultimate solution for templates of periodic patterns at scales of 10 nm and less.

To give a summing-up, nanoimprinting lithography has some unique advantages over other forms of lithography (such as photolithography and electron beam lithography). They include the following:
a) Lower cost than traditional photolithography;
b) Well suited for applications in biotechnology;
c) Well suited for applications in plastic electronics;
d) Well suited for applications involving large or nonplanar (nonflat) surfaces;
f) More pattern-transferring methods or options than traditional lithography 1) techniques;
g) Does not need a photo-reactive surface to create a nanostructure;
and
h) Smaller details than photolithography in laboratory settings.

### Metallization

Metallization is the fabrication step in which proper interconnection of circuit elements is made. Aluminum is a popular metal used to interconnect ICs, both to make ohmic contact to the devices and connect these to the bonding pads on the chip's edge. Aluminum adheres well to both silicon and silicon dioxide, can be easily vacuum deposited (since it has a low boiling point), and has high conductivity. In addition to pure aluminum, alloys of aluminum are used to form IC interconnections for different performance-related reasons. For example, small amounts of copper are added to reduce the potential for electromigration effects (in which current applied to the device induces mass transport of the metal). Small amounts of silicon also are added to aluminum metallization to reduce the formation of metal “spikes” that occur over contact holes.

Filament evaporation is accomplished by gradually heating a filament of the metal to be evaporated. This metal may come in one of several different forms: pellets, wire, crystal, etc. Gold, platinum and aluminum are metals typically used. The PMOS process uses aluminum wire. The metal is placed in a basket. Electrodes are connected to either side of the basket and a high current passed through it, causing the basket to heat. As power (and therefore heat) is increased, the metallic filament partially melts and is eventually vaporized. In this way, atoms of aluminum break free from the filament and deposit onto the wafers. While filament evaporation is the simplest of all metallization approaches, problems of contamination during evaporation preclude its widespread use in IC fabrication.

Flash evaporation uses the principle of thermal-resistance heating to evaporate metals. Like filament evaporation, flash evaporation offers radiation-free coatings. This technique does offer some benefits beyond filament evaporation: contamination-free coatings, speed or good throughput of wafers, and the ability to coat materials or layers that are composite in nature. Flash evaporation is accomplished by passing a continuous supply of the material to be evaporated over a ceramic structure that provides heat. The sources are usually either powder of thin wires. The ceramic “flash” bar is heated between two positively and negatively charged posts, and the metal evaporates as the source material is fed onto the bar.

Electron-beam evaporation works by focusing an intense beam of electrons into a crucible, or “pocket,” in the evaporator that contains the aluminum. As the beam is directed into the source area, the aluminum is heated to its melting point, and eventually, evaporation temperature. The benefits or this technique are speed and low contamination, since only the electron beam touches the aluminum source material.

Aluminum sputtering is used commonly in IC metallization processes and is popular because the adhesion of deposited metals is excellent. RF sputtering is done by ionizing inert gas particles in an electric field (producing a gas plasma) and then directing them toward the source or target, where the energy of these gas particles physically dislodges, or “sputters off,” atoms of the source material. Sputtering is a versatile tool in that many materials can be deposited by this technique, using not only RF but also DC power sources.

### Example

The present invention for a novel hybrid type (metal and polymer) tooling has been employed to achieve quality molding. As discussed, it includes a metallic layer containing micron scale features on the surface and a polymer layer attached to the back side. The polymer layer is designed to function as passive heating media to maintain the tooling surface hot for better filling in molding process.

Aluminum and titanium were selected for the metallic layer and the molding quality, and these hybrid toolings were compared with silicon tooling with FOTS (trichloro-[1H,1H,2H,2H-perfluorooctyl]-silane) coated silicon wafer with similar patterns on the surface to evaluate the effect of tooling surface under moderate injection molding condition. The patterns of rectangular shape trenches with aspect ratio were around 2.3:1. Depth ratio (part feature height/tooling feature height) was used for comparing the replication quality. In addition, transient heat transfer analysis was done by using ANSYS for cooling time optimization. The surface of the tooling and molded part were characterized by using Zygo NewView6000 3D optical profiler and scanning electron microscope (JEOL JSM-7401F).

The novel tooling offers several significant advantages as an advanced microtooling for next generation, such as high-resolution, toughness, high molding quality through better filling, and more options in surface material selection. Thus, the tooling materials for comparison are as shown in Table 1.

TABLE 1
Tooling Materials

| Tooling | Material |
|---|---|
| Al-P | Aluminum-Polymer |
| Ti-P | Titanium-Polymer |
| Si-FOTS | Silicon-FOTS coating |

### Experimental Procedure

Injection molding grade general purpose polystyrene (DOW STYRON 615APR, MFI=14) was used. It has medium heat resistance and high flow, and is recommended for thin-wall applications in medical and packaging/disposables applications.

### Injection Molding

The procedure of preparing FOTS silicon coated wafer tooling has been described in U.S. Provisional Patent Application Ser. No. 60/823,582, entitled “Microcontact Printing Stamps and Methods for Their preparation”, the entire contents of which are incorporated herein by reference. The FOTS silicon coated wafer tooling was used to evaluate the performance of the present invention for a novel hybrid metal polymer tooling.

To allow mounting in the insert mold, the patterned silicon wafers were cut to 14 mm×14 mm rectangles using a wafer dicing machine. During the mounting process, two of 0.4-mm thick pieces of polytetrafluoroethylene (PTFE) sheet was inserted between the silicon insert and mold to protect the silicon insert from the high forces generated during the molding process. The silicon insert and the PTFE sheet are placed into the custom-made mold. PTFE sheet was not used for the other two metal-polymer hybrid toolings.

Molding was performed using a 3 ton micro injection molding machine (Nissei, model: AU3E) with a two-stage injection unit. The nozzle, joint, and plunger temperatures were set at 216° C. which is a lower bound of recommended temperature by manufacturer and the cooling time was set to 12 seconds. Mold coolant temperature, and injection velocity were shown in Table 2.

TABLE 2
Molding Conditions

| | |
|---|---|
| Melt temperature (° C.) | 216~227 |
| Mold temperature (° C.) | 49~71 |
| Injection velocity (mm/s) | 120 |
| Injection pressure (MPa) | 45 |
| Cooling time (s) | 16 |

Injection pressure was set to 45 MPa and the average cycle time was about 19 seconds. Injection molding was done under moderate conditions to compare the performance of the three tooling materials.

### Characterization

A scanning electron microscope (FE-SEM) and Zygo NewView6000 3D optical profiler were used to characterize the tooling and molded surface features. Depth ratio (the ratio of part depth or height to the tooling depth or height) was used to quantifying the replication.

### Results

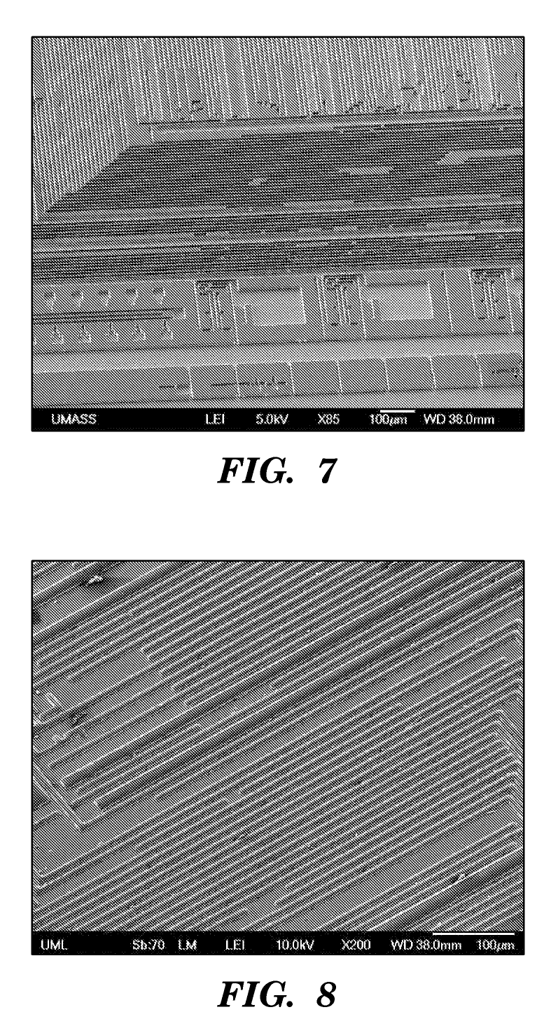

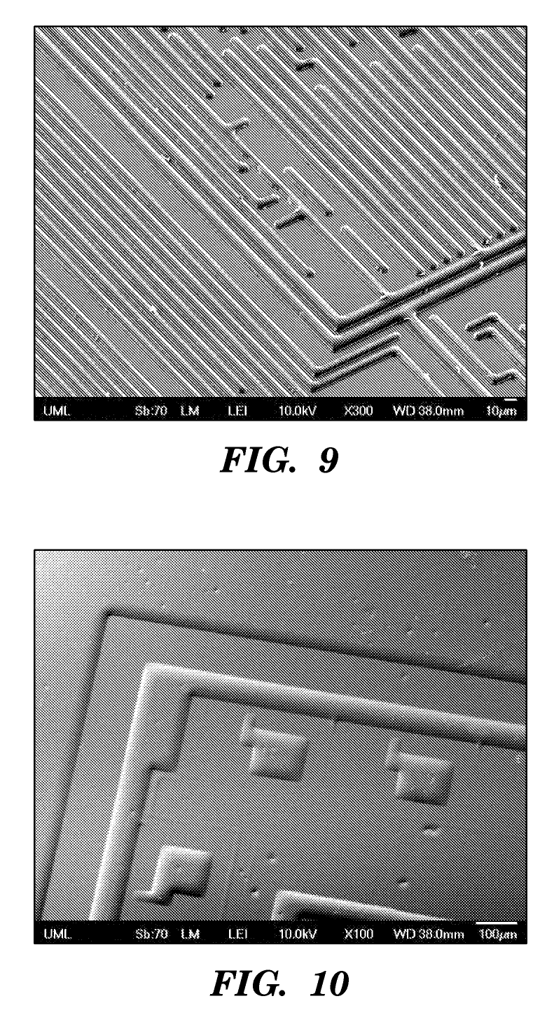

FIG. 7-9 shows SEM images of three tooling surface that were used for comparison. In FIG. 7, the silicon tooling with FOTS coating has well-defined features with average height of 9.2 μm on the surface. The shape of features can be divided into two categories; lines and pads. The average width of the line is 4 μm and that of pad is over 50 μm. FIG. 8 is the surface of aluminum-polymer tooling in accordance with the present invention, and FIG. 9 is titanium-polymer tooling surface in accordance with the present invention. The corners of the features on metal-polymer tooling are slightly rounded height seems to be shorter than that of silicon tooling with FOTS coating. This is due to the fact that the SEM images in FIGS. 7-9 are just representative pictures of the tooling and they are not the exact locations that have been used for molding.

FIGS. 10-12 show the surfaces of the injection molded parts under the similar conditions as shown in Table 2 above.

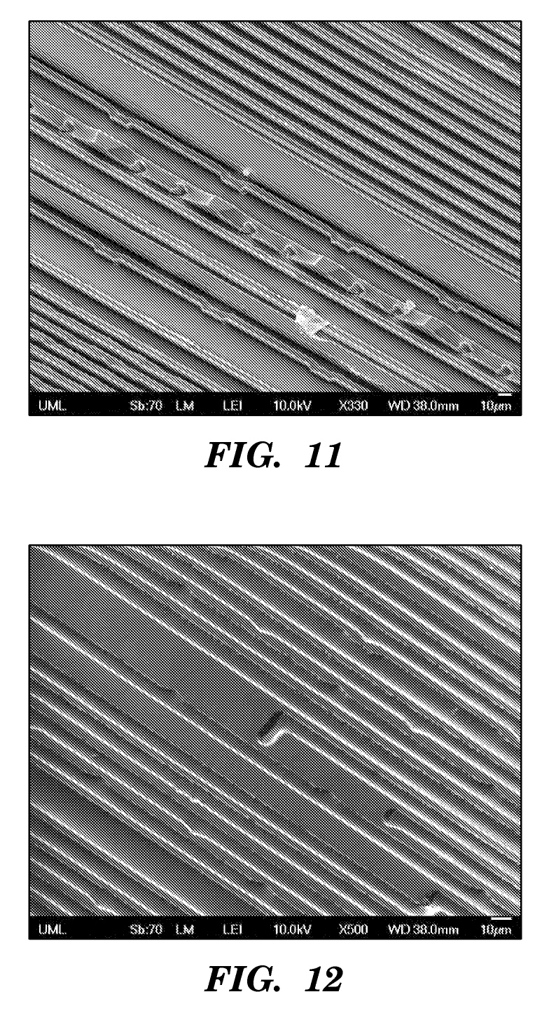

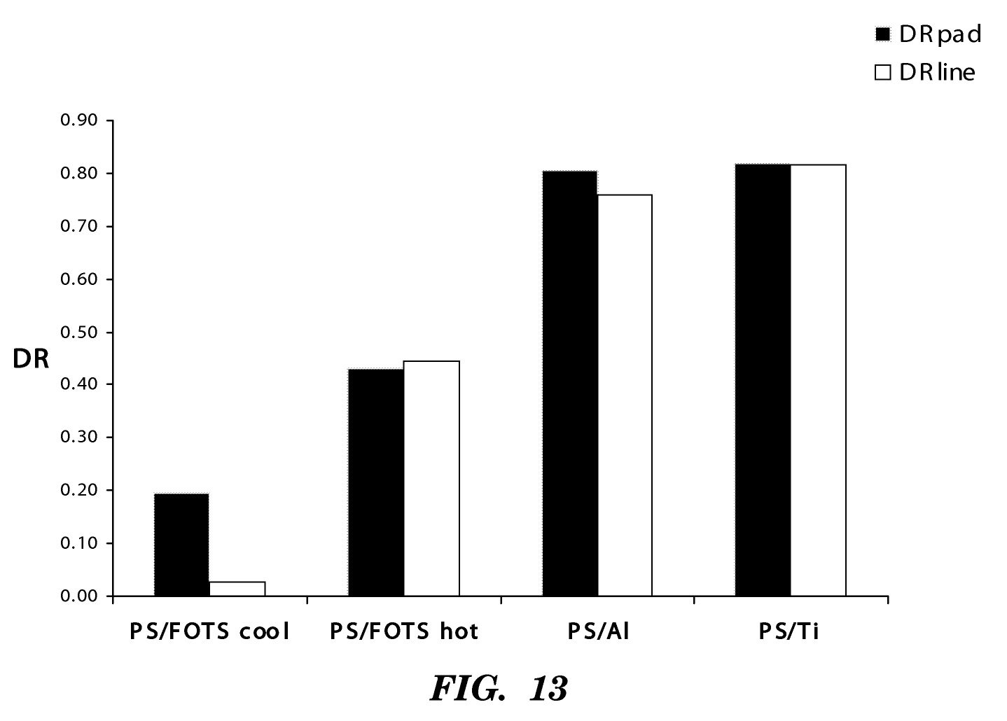

The molded part quality from silicon tooling with FOTS coating was very poor as in FIG. 10. Relatively narrow lines were almost not reproduced due to poor filling. On the other hand, both of the metal-polymer tooling, FIGS. 11 and 12, were able to achieve much higher depth ratios (about 0.80) even under moderate molding conditions. The visible defects and rough edges on the molded part surface shown in FIGS. 10 and 11 are expected to be improved by further optimization of process conditions. FOTS coated silicon tooling successfully delivered high depth ratio of 0.92 with thermoplastic polyurethane in previous research (A. D'Amore, M. Gabriel, W. Haese, H. Schift, and W. Kaiser. In Kunststoffe plas europe, 2004; Vol. 2, pp 4-7). The SEM image in FIG. 12 does not seem to show any rough surface or edges due to adhesion in demolding. In FIG. 13, the molding quality in smaller feature sized lines were extremely poor and it could be improved under elevated mold and melt temperature, but still could not match the depth ratio of metal-polymer tooling. The reason for poor molding result from the silicon tooling with well-defined features may be more effectively explained by heat transfer analysis. The molding results are shown in Table 3 as follows.

TABLE 3
Molding Results

| | Tₘ | T_{w} | Vᵢₙⱼ | Pad | Line | H_{T} | | |
|---|---|---|---|---|---|---|---|---|
| | (° C.) | (° C.) | (mm/s) | (μm) | (μm) | (μm) | DR_{Pad} | DR_{Line} |
| PS/FOTS (cool) | 216 | 60 | 120 | 1.8 | 0.3 | 9.2 | 0.20 | 0.03 |
| PS/FOTS (hot) | 227 | 71 | 120 | 4.0 | 4.1 | 9.2 | 0.43 | 0.45 |
| PS/Al | 216 | 49 | 120 | 10.0 | 9.4 | 12.41 | 0.81 | 0.76 |
| PS/Ti | 216 | 49 | 120 | 10.2 | 10.1 | 12.41 | 0.82 | 0.82 |

### Heat Transfer Analysis

Two objectives for performing a heat transfer analysis on this system include 1) heat transfer analysis considering the effects of the tooling material, and 2) verification of cooling time for this process. It would be desirable to find an optimal cooling time for ejecting the molded part when the polymer melt cools down to reach slightly higher temperature than glass transition temperature since it was very difficult to demold without damaging the part when the polymer melts cools down below glass transition temperature. Transient heat transfer analysis for cooling was done using a commercial finite element analysis package, ANSYS, without considering the microscale patterns. The initial condition was set at 216° C. for the polystyrene melt, and 49° C. for the mold temperature. For the analysis, density, thermal conductivity, and heat capacity of materials were input with dimensions. For actual injection molding, 12 seconds of cooling time have been used.

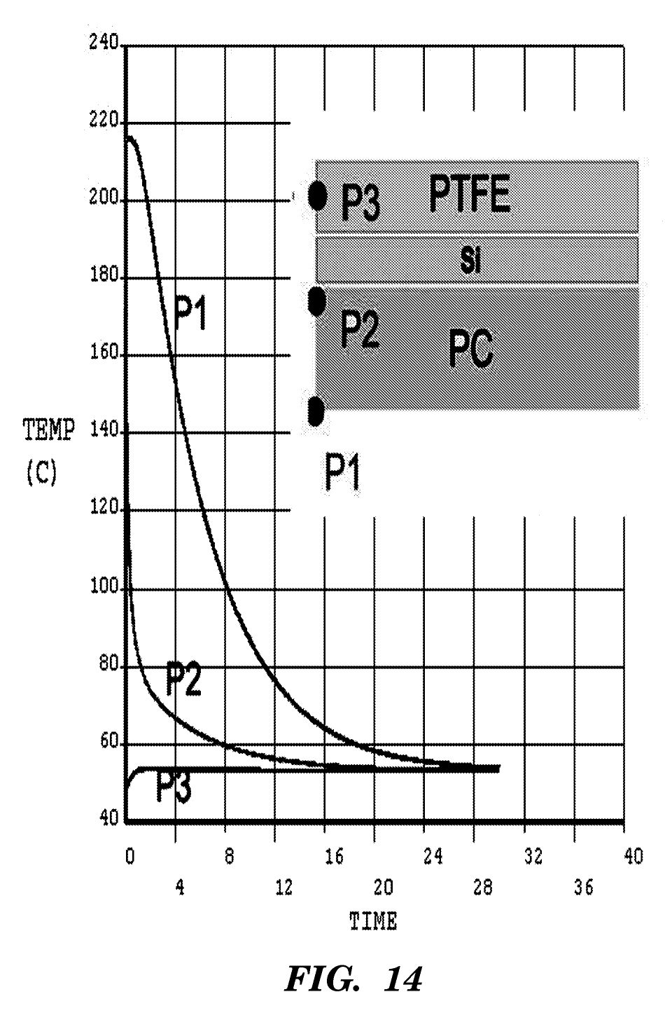

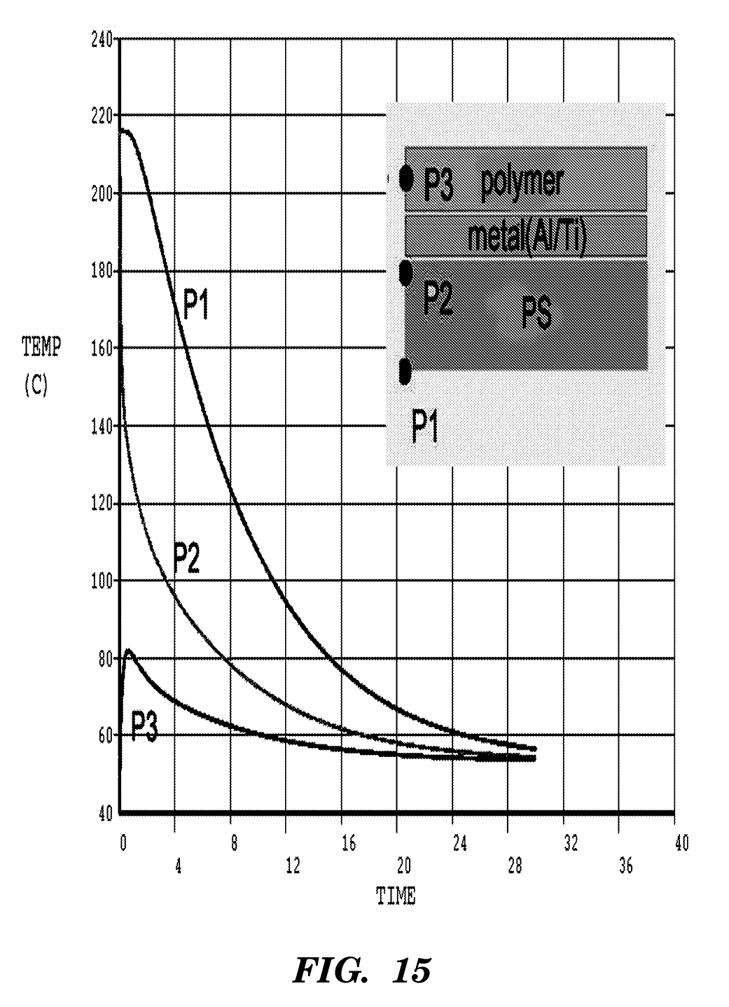

FIGS. 14 and 15 illustrate heat transfer analysis results with FOTS coated silicon tooling and aluminum-polymer tooling. The result of titanium-polymer was omitted since it was almost the same as that of aluminum-polymer tooling. The location of P1 designates the inside of injected polymer in the center, P2 is the surface of polymer contacting the tooling surface, which is more critical area in micro molding quality, and P3 is the centerline of the tooling. It is shown that a cooling time of 12 seconds were more than sufficient for both of the tooling to cool the polymer melt below the glass transition temperature of 98° C. for polystyrene in FIGS. 14 and 15. The major difference occurred in heat analysis result between the two tooling materials was the temperature profile at location P2. It took less than 1 second for the injected polymer surface temperature to reach to glass transition with silicon tooling, but it took almost 4 seconds with aluminum-polymer tooling. This may be due to the insulating nature of the polymer backing material attached to the metal layer to hold the tooling surface hot while the injected polymer fill in the small features. This agrees to the simulation result done by Kang et al. using PTFE as a passive heating media for enhancement of optical disk replication. Y. Kim, J. Bae, H. Kim and S. Kang, Modeling of passive heating for replication of sub-micron patterns in optical disk substrates, Journal of Physics D: Applied Physics 37(9): 1319-1326 (2004).

### Conclusion

The novel metal-polymer hybrid tooling was able to produce molding results superior to those obtained from silicon tooling under the same processing conditions. It could enhance the filling in the small features by maintaining the tooling surface hot due to the insulating polymer layer attached to the metal surface as a part of tooling. This could be an inexpensive solution for high-resolution micro/nano tooling.

### Metal Tooling

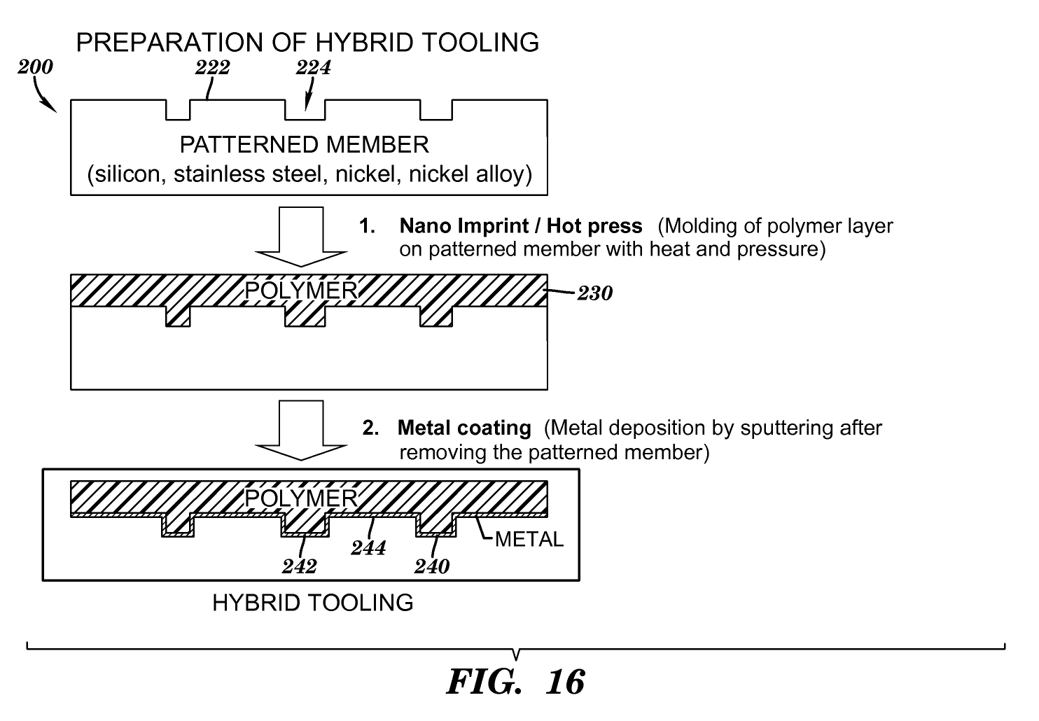

FIG. 16 is a diagrammatic illustration of another embodiment of a method 200 for forming a novel metal-polymer hybrid tooling in accordance with the present invention. For example, in this illustrative embodiment, the present invention may initially include providing a surface of a member 220 such formed from as stainless steel, nickel, or nickel alloy to a desired resolution. For example, the patterned surface may have features such as lands 222 and grooves 224. The size of the lands and grooves may be between about 0.01 microns (μm) and about 100 microns wide and a height or depth between about 0.01 microns and about 800 microns. Preferably, the size of the lands and grooves may be between about 0.01 micron and about 100 microns wide and a height or depth between about 0.01 micron and about 800 microns, e.g., with an aspect ratio of up to about 8. The size of the lands and grooves may also include lands and grooves about 10 microns (μm) wide and a height or depth of about 10 microns resulting in an aspect ration of 1. Additional ranges for the various features of the patterned surface of the member may be suitably selected depending on the filed of application such as for forming biosensors, optical devices, and microfluidics.

The next step may employ a nanoimprinting, melting, or depositing of a polymer material onto the patterned member. The pattern is then transferred to the polymer layer 230 such as a polymer sheet. The polymer may be any thermoplastic or thermoset polymer. For example, the polymer layer may be polycarbonate, polyimide, polyester, liquid crystal polymer, or other suitable materials. Another process such as nanoimprint lithography may be employed instead which transfer or copies the pattern from the member to polymer base sheet by applying compression, heat and pressure. The overall cycle time may be about 15 minutes. While hot press with heat may be employed, dedicated nanoimprint equipment may be preferable and may afford better results.

The next step is applying a metal coating 240 on the nanoimprinted polymer layer. For example, the metallic layer may be deposited using a sputtering process. The nanoimprinted polymer layer may be coated, for example using a sputtering process, employing at least one of aluminum, titanium, nickel, chromium, tungsten, gold, or and alloys containing at least one of aluminum, titanium, nickel, chromium, tungsten, gold, titanium on the patterned polymer layer surface which may form a major component or percentage of the alloy. Depending on the capability of sputtering equipment and the type of metal deposited, the required time may vary significantly, but generally no more than one hour. The typical thickness of the deposited metallic layer is about 0.5 micros to about 500 microns.

The resulting tooling may include a patterned surface having features such as lands 242 and grooves 244. The size of the lands and grooves of the tooling may be between about 0.01 microns (μm) and about 500 microns wide and a height or depth between about 0.01 micron and about 800 microns. Preferably, the size of the lands and grooves of the tooling may be between about 0.01 microns and about 100 microns wide and a height or depth between about 1 micron and about 800 microns, e.g., having an aspect ratio up to 8. The size of the lands and grooves of the tooling may also include lands and grooves about 10 microns wide and a height or depth of about 10 microns resulting in an aspect ratio of 1.

Additional ranges for the various features of the patterned surface of the tooling may be suitably selected depending on the filed of application such as for forming biosensors and microfluidics. For example, the size of the lands and grooves of the tooling may be about 50 microns wide and a height or depth about 50 microns. For optical devices, the size of the lands and grooves of the tooling may be about 100 microns wide and a height or depth about 100 microns.

Thus, while various embodiments of the present invention have been illustrated and described, it will be appreciated to those skilled in the art that many changes and modifications may be made thereunto without departing from the spirit and scope of the invention.

1. A method for forming a metal-polymer hybrid tooling for molding a plurality of parts having micro features, the method comprising:
patterning a surface of a member having patterned features having width dimension of between about 0.01 microns and about 100 microns, and a height dimension of between about 0.01 microns and about 800 microns;
engaging a polymer layer with the patterned features of the surface of the member to form the polymer layer having a reverse of the patterned surface the member;
removing the patterned polymer layer to expose a patterned polymer layer surface;
depositing a metallic layer on the patterned polymer layer surface, the metallic layer comprising a thickness of between about 0.5 microns and about 500 microns, and patterned features having width dimension of between about 0.01 microns and about 800 microns; and
wherein the deposited metallic layer on the patterned polymer layer is operable to form parts having patterned features having a width dimension between about 0.01 microns and about 500 microns and a height dimension of between about 0.01 micron and about 800 microns.

2. The method of claim 1 wherein the polymer layer comprises a polymer sheet, and the engaging comprises applying heat to the polymer sheet and compressing the heated polymer sheet onto the patterned features of the surface of the member to form the polymer sheet having a reverse of the patterned surface the member.

3. The method of claim 1 wherein the patterning the surface of the member comprises patterned features having width dimension of between about 0.01 microns and about 100 microns, and a height dimension of between about 0.01 micron and about 100 microns, and wherein the deposited metallic layer on the patterned polymer layer is operable to form parts having features having a width dimension between about 0.01 microns and about 100 microns and a height dimension of between about 1 micron and about 800 microns.

4. The method of claim 1 wherein the patterning a surface of a silicon wafer comprises patterned features having width dimension of between about 0.01 microns and about 100 microns, and a height dimension of between about 0.01 micron and about 800 microns, and wherein the deposited metallic layer on the patterned polymer layer is operable to form parts having features having a width dimension between about 0.01 microns and about 500 microns and a height dimension of between about 1 micron and about 800 microns.

5. The method of claim 1 wherein the deposited metallic layer on the patterned polymer layer is operable to form parts having features having a width dimension about 50 microns and a height dimension of about 50 microns.

6. The method of claim 1 wherein the patterning the surface of the member comprises patterned features having width dimension of between about 10 microns, and a height dimension of between about 10 microns, and wherein the deposited metallic layer on the patterned polymer layer is operable to form parts having features having a width dimension about 10 microns and a height dimension of about 10 microns.

7. The method of claim 1 wherein the patterning comprises patterning the surface of the member using at least one of a photolithography process, an electrochemical process, and a electroplating process.

8. The method of claim 1 wherein the polymer layer comprises at least one of a thermoplastic polymer and a thermoset polymer.

9. The method of claim 1 wherein the polymer layer comprises at least one of polycarbonate, polyimide, polyester and liquid crystal polymer.

10. The method of claim 1 wherein the polymer layer has a thickness of greater than about 100 microns.

11. The method of claim 1 wherein the depositing the polymer material comprises melting the polymer material and depositing the melted polymer layer onto the patterned features of the surface of the member.

12. The method of claim 1 wherein the depositing the metallic layer comprises depositing the metallic layer using a sputtering process.

13. The method of claim 1 wherein the depositing the metallic layer comprises depositing at least one of aluminum, titanium, nickel, chromium, tungsten, gold, titanium, and alloys containing at least one of aluminum, titanium, nickel, chromium, tungsten, gold, and titanium on the patterned polymer layer surface.

14. The method of claim 1 wherein the depositing metallic layer comprises depositing the metallic layer having a thickness of about 500 microns.

15. A method for forming a plurality of parts having micro features, the method comprising:
providing the metal-polymer hybrid tooling of claim 1;
providing a moldable material; and
forming the moldable material using the metal-polymer hybrid tooling to produce the plurality of parts having features having a width dimension between about 0.1 microns and about 500 microns and a height dimension of between about 0.01 micron and about 800 microns.

16. The method of claim 15 wherein the forming comprises an injection molding process.

17. A method for forming a plurality of parts having micro features, the method comprising:
providing the metal-polymer hybrid tooling of claim 3;
providing a moldable material; and
forming the moldable material using the metal-polymer hybrid tooling to produce the plurality of parts having features having a width dimension between about 0.1 microns and about 100 microns and a height dimension of between about 1 micron and about 800 microns.

18. The method of claim 17 wherein the forming comprises an injection molding process.

19. A method for forming a plurality of parts having micro features, the method comprising:
providing the metal-polymer hybrid tooling of claim 4;
providing a moldable material; and
forming the moldable material using the metal-polymer hybrid tooling to produce the plurality of parts having features having a width dimension between about 0.5 microns and about 500 microns and a height dimension of between about 1 micron and about 800 microns.

20. The method of claim 19 wherein the forming comprises an injection molding process.

21. A method for forming a plurality of parts having micro features, the method comprising:
providing the metal-polymer hybrid tooling of claim 5;
providing a moldable material; and
forming the moldable material using the metal-polymer hybrid tooling to produce the plurality of parts having features having a width dimension of about 50 microns and a height dimension of about 50 microns.

22. The method of claim 21 wherein the forming comprises an injection molding process.

23. A method for forming a plurality of parts having micro features, the method comprising:
providing the metal-polymer hybrid tooling of claim 5;
providing a moldable material; and
forming the moldable material using the metal-polymer hybrid tooling to produce the plurality of parts having features having a width dimension about 10 microns and a height dimension of about 10 microns.

24. The method of claim 23 wherein the forming comprises an injection molding process.

25. The method of claim 1 wherein the member comprises a silicon wafer.

26. The method of claim 1 wherein the member comprises a metal.

27. The method of claim 1 wherein the member comprises at least one of stainless steel, nickel, and nickel alloy.

28. The method of claim 1 wherein the deposited metallic layer on the patterned polymer layer is operable to form parts having features having a width dimension about 100 microns and a height dimension of about 100 microns.

29. A method for forming a plurality of parts having micro features, the method comprising:
providing the metal-polymer hybrid tooling of claim 28;
providing a moldable material; and
forming the moldable material using the metal-polymer hybrid tooling to produce the plurality of parts having features having a width dimension of about 100 microns and a height dimension of about 100 microns.

30. The method of claim 29 wherein the forming comprises an injection molding process.

31. A method for forming a metal-polymer hybrid tooling for molding a plurality of parts having micro features, the method comprising:
engaging a polymer layer with the patterned features of the surface of the member to form the polymer layer having a reverse of the patterned surface the member, the surface of the member having patterned features having width dimension of between about 0.01 microns and about 100 microns, and a height dimension of between about 0.01 microns and about 800 microns;
removing the patterned polymer layer to expose a patterned polymer layer surface;
depositing a metallic layer on the patterned polymer layer surface, the metallic layer comprising a thickness of between about 0.5 microns and about 500 microns, and patterned features having width dimension of between about 0.01 microns and about 800 microns; and
wherein the deposited metallic layer on the patterned polymer layer is operable to form parts having patterned features having a width dimension between about 0.01 microns and about 500 microns and a height dimension of between about 0.01 micron and about 800 microns.

32. The method of claim 31 wherein the member comprises a silicon wafer.

33. The method of claim 31 wherein the member comprises a metal.

34. The method of claim 31 wherein the member comprises at least one of stainless steel, nickel, and nickel alloy.

35. A method for forming a plurality of parts having micro features, the method comprising:
providing the metal-polymer hybrid tooling of claim 31;
providing a moldable material; and
forming the moldable material using the metal-polymer hybrid tooling to produce the plurality of parts having features having a width dimension between about 0.1 microns and about 500 microns and a height dimension of between about 0.01 micron and about 800 microns.

36. A method for forming a plurality of parts having micro features, the method comprising:
providing the metal-polymer hybrid tooling of claim 31;
providing a moldable material; and
forming the moldable material using the metal-polymer hybrid tooling to produce the plurality of parts having features having a width dimension between about 0.1 microns and about 100 microns and a height dimension of between about 1 micron and about 800 microns.

37. A method for forming a plurality of parts having micro features, the method comprising:
providing the metal-polymer hybrid tooling of claim 31;
providing a moldable material; and
forming the moldable material using the metal-polymer hybrid tooling to produce the plurality of parts having features having a width dimension between about 0.5 microns and about 500 microns and a height dimension of between about 1 micron and about 800 microns.

38. A method for forming a plurality of parts having micro features, the method comprising:
providing the metal-polymer hybrid tooling of claim 31;
providing a moldable material; and
forming the moldable material using the metal-polymer hybrid tooling to produce the plurality of parts having features having a width dimension about 10 microns and a height dimension of about 10 microns.

39. A method for forming a plurality of parts having micro features, the method comprising:
providing the metal-polymer hybrid tooling of claim 31;
providing a moldable material; and
forming the moldable material using the metal-polymer hybrid tooling to produce the plurality of parts having features having a width dimension about 50 microns and a height dimension of about 50 microns.

40. A method for forming a plurality of parts having micro features, the method comprising:
providing the metal-polymer hybrid tooling of claim 31;
providing a moldable material; and
forming the moldable material using the metal-polymer hybrid tooling to produce the plurality of parts having features having a width dimension about 100 microns and a height dimension of about 100 microns.
